(19) United States
(12) Patent Application Publication
(10) Pub. No.: US 2011/0215548 A1
(43) Pub. Date: Sep. 8, 2011

(54) Bicycle Drive System

(76) Inventor: Paul Joseph Horwat, JR., Aurora, CO (US)

(21) Appl. No.: 13/031,409

(22) Filed: May 4, 2011

Related U.S. Application Data
(60) Provisional application No. 61/310,676, filed on Mar. 4, 2010.

(51) Int. Cl. B62M 1/02; B62K 19/06; B62M 9/00

(52) U.S. Cl. 280/261; 280/281.1

(57) ABSTRACT

The modified gear configuration of the bicycle drive system ultimately allows the rider to operate the bicycle in a very efficient manner. The gears allow for increased torque and power distribution to the bike's rear wheel. In turn, this reduces the amount of effort required to power the bicycle. This allows the rider to conserve energy, particularly when traveling long distances, which makes it easier for the rider to reach faster speeds and climb hills more easily. The bicycle also features taller wheel rims and tires which allow the rider to cover more distance with each pedal rotation in addition to providing a smoother ride.

### PRIORITY CLAIM

I hereby claim priority to the earlier filed provisional application date of Mar. 4, 2010 Provisional application No. 61/310,676

### CROSS-REFERENCE TO RELATED APPLICATIONS

Applicable, See attachment 1, Preliminary Patentability Search and Opinion

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of human powered transportation. More particularly, the present invention is in the technical field of bicycle gearing.

Conventional rider-selectable multi-speed bicycles typically require the operator to manipulate various levers or controls. The adjustment of the gear selection controls is necessary to negotiate inclines, hills, or to attain a faster speed. Moving such devices typically requires the operator to remove one hand from the handle bar to adjust the controls. Selecting a gear to attain a higher speed increases the rider's pedal effort. Further, it is not uncommon for some riders not to utilize higher speed gearing to attain faster speeds due to the bicycles design.

### SUMMARY OF THE INVENTION

The present invention is a bicycle with a gearing configuration which eliminates the need for rider-selectable speed controls to attain higher than average speeds. In Addition, pedal effort is substantially reduced.

### BRIEF DESCRIPTION OF THE DRAWINGS

FIG. 1 is a side view of the bicycle drive system of the present invention;

FIG. 2 is a gear configuration perspective view;

FIG. 3 is a performance chart comparing pedal speed to attainable speed in miles per hour;

### DETAILED DESCRIPTION OF THE PREFERRED EMBODIMENTS

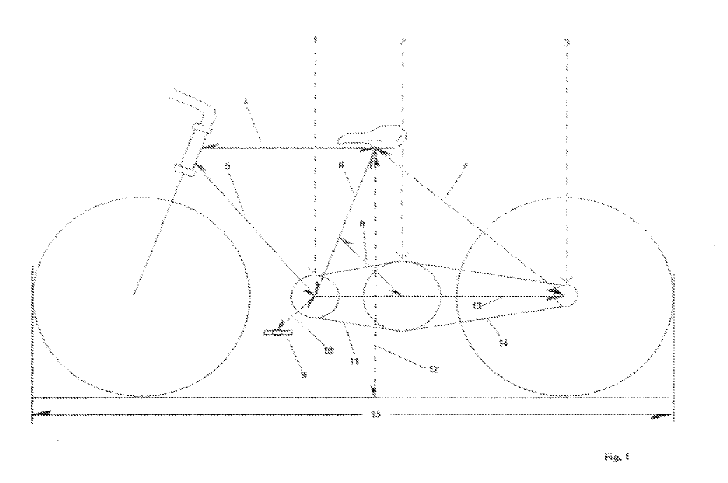

Referring to the invention in more detail in FIG. 1, the bicycle frame is constructed from industry standard light weight steel tubing. The frame is similar in design to a mountain bike frame and measures 80⅝ inches overall 15, the seat height 12 is 36½ inches. The frame features a head tube complete with a front fork and handle bars, as well as a top cross tube 4, down tube 5, and seat tube 6 in its center. The bike also includes a rear wheel structural support 7.

In further detail, still referring to the invention in FIG. 1 the bicycle includes features typically found on a mountain bike, such as an adjustable seat post, as well as handgrips on its handle bars and the appropriate types of front and rear brakes.

The bicycle features a pedal and crankset assembly 9, 10 in its lower central portion. This crankset consists of a single, 28-tooth torque-multiplying primary chain ring sprocket 1. The 28-tooth chain ring sprocket engages an additional geared sprocket assembly 2, which is secured to a crankset incorporated into a modified section of the bike's frame 13. The modified section of the frame features a lengthened design and includes an angled 7½ inch angled support 8, connecting the frames seat tube 6 to the second crankset housing.

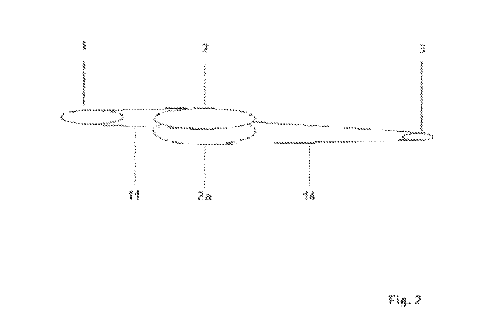

Referring to the invention in FIG. 2, the secondary crankset 2, 2a features two 48-tooth tandem speed-multiplying chain ring sprockets. The inner sprocket 2 engages with the 28-tooth torque-multiplying chain ring sprocket via a short chain 11. The outer sprocket 2a engages with the bike's rear wheel hub assembly via a long chain 14.

The rear wheel hub is fitted with a single gear final drive sprocket 3 featuring 10-teeth. The bicycle also features 29-inch tall wheel rims and 29-inch by 2.10-inch tires that feature a rollout measurement of 7½ feet.

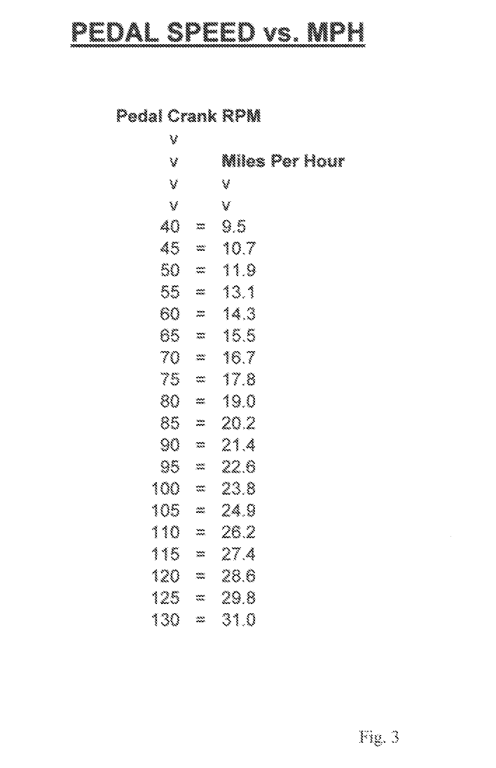

The advantages of the present invention include the innovative configuration of sprockets and cranksets which allow the operator to impart a tremendous amount of torque to the rear wheel with substantially reduced pedal effort. This, combined with the bike's larger wheel rims and tires allows for a more efficient use of energy, and enables the rider to reach faster speeds FIG. 3, and travel farther distances with less effort. In Addition, this configuration results a smoother ride, which enhances comfort and less reduction in speed when traveling over bumps or other anomalies on paved surfaces.

In broad embodiment, the present invention is a bicycle with a drive system that multiplies the rider's pedal effort by over 1.7 times.

The foregoing discussion which follows describes the preferred embodiments of the present invention. It should be understood that changes may be made without departing from the essence of the invention. In this regard, it is intended that such changes would still fall within the scope of the patent. It simply is not practical to describe and claim all possible revisions to the present invention which may be accomplished. To the extent any revision utilizes the essence of any one of the features of the present invention it would naturally fall within the breadth of protection encompassed by this patent. This is particularly true for the present invention since its basic concepts and understandings are fundamental in nature and can be broadly applied. Any changes or modifications made without departing from the broad aspects of the present invention are intended to be encompassed by this patent.

The embodiments of the invention in which an exclusive property or privilege is claimed are defined as follows:

1. Referring to the invention in FIG. 1, the Bicycle Drive System frame is constructed from industry standard light weight steel tubing. The frame is similar in design to a mountain bike frame and measures 80⅝ inches overall 15, the seat height 12 is 36½ inches. The frame features a head tube complete with a front fork and handle bars, as well as a top cross tube 4, down tube 5, and seat tube 6 in its center. The bike also includes a rear wheel structural support 7. In further detail, still referring to the invention in FIG. 1 the bicycle includes features typically found on a mountain bike, such as an adjustable seat post, as well as handgrips on its handle bars and the appropriate types of front and rear brakes.

2. The Bicycle Drive System features a pedal and crankset assembly 9, 10 in its lower central portion. This crankset consists of a single, 28-tooth torque-multiplying primary chain ring sprocket 1. The 28-tooth chain ring sprocket engages an additional geared sprocket assembly 2, which is secured to a crankset incorporated into the frame 13. The modified section of the frame features a lengthened design and includes an angled 7½ inch angled support 8, connecting the frames seat tube 6 to the second crankset housing.

3. The combination defined in claim 2, referring to the invention in FIG. 2. The secondary crankset 2, 2a features two 48-tooth tandem speed-multiplying chain ring sprockets. The inner sprocket 2 engages with the 28-tooth torque-multiplying chain ring sprocket via a short chain 11. The outer sprocket 2a engages with the bike's rear wheel hub assembly via a long chain 14.

4. The combination defined in claim 3, the rear wheel hub is fitted with a single gear final drive sprocket 3 featuring 10-teeth. The bicycle also features 29-inch tall wheel rims and 29-inch by 2.10-inch tires that feature a rollout measurement of 7½ feet.

5. The configuration of sprockets and cranksets allow the operator to impart 1.7 times the torque to the rear wheel with substantially reduced pedal effort. This, combined with larger wheel rims and tires allows for a more efficient use of energy, and enables the rider to reach faster speeds FIG. 3, and travel farther distances with less effort.
